(19) United States
(12) Patent Application Publication
(10) Pub. No.: US 2022/0274590 A1
(43) Pub. Date: Sep. 1, 2022

(54) TRANSPORT PLANNING SYSTEM, TRANSPORT PLANNING METHOD AND PROGRAM

(71) Applicant: TOYOTA JIDOSHA KABUSHIKI KAISHA, Toyota-shi (JP)

(72) Inventors: Yohei MORIKUNI, Toyota-shi (JP); Shintaro YOSHIZAWA, Nagoya-shi (JP)

(21) Appl. No.: 17/651,148

(22) Filed: Feb. 15, 2022

(30) Foreign Application Priority Data
Mar. 1, 2021 (JP) 2021-031738

(51) Int. Cl. B60W 30/09; B60W 60/00; G06K 9/62

(52) U.S. Cl. CPC B60W 30/09; B60W 60/0017; G06K 9/6218; B60W 2554/4049

(57) ABSTRACT

A transport planning system includes a grouping unit configured to, based on transport path information, feature each of transport requests each including information on a set of start node and end node by using at least one of (a) a quantity that leads to values apart from each other for transport requests at locations apart from each other and (b) a quantity that leads to values close to each other for transport requests of which transport paths for automated guided vehicles overlap, and group the transport requests based on the featured quantities, an assigning unit configured to assign the grouped set of transport requests to each automated guided vehicle, and a planning unit configured to make a plan for causing each automated guided vehicle to travel based on the assigned set of transport requests such that the automated guided vehicles do not collide with each other.

### CROSS-REFERENCE TO RELATED APPLICATION

This application claims priority to Japanese Patent Application No. 2021-031738 filed on Mar. 1, 2021, incorporated herein by reference in its entirety.

### BACKGROUND

### 1. Technical Field

The disclosure relates to a transport planning system, a transport planning method, and a program that plan transportation of automated guided vehicles.

### 2. Description of Related Art

As the number of transport requests, the number of automated guided vehicles, or the numbers of nodes and edges that represent paths and the like in transporting packages and the like increases, the number of combinations of the numbers of transport requests, automated guided vehicles, nodes, and edges explosively increases. For this reason, there is an inconvenience that it takes a great amount of computation time to make an optimal transport plan. In contrast, there is known a transport planning system that makes an optimal transport plan for automated guided vehicles by using a genetic algorithm (see, for example, Japanese Unexamined Patent Application Publication No. 2001-209430 (JP 2001-209430 A)).

### SUMMARY

However, since the genetic algorithm searches for a solution through an accidental change, the transport planning system may make a different transport plan even for the same transport request. For this reason, a computation time to make an optimal transport plan fluctuates, with the result that the computation time may not be sufficiently reduced.

The disclosure provides a transport planning system, a transport planning method, and a program that are capable of sufficiently reducing a computation time to make a transport plan.

An aspect of the disclosure relates to a transport planning system. The transport planning system includes a transport request grouping unit configured to, based on transport path information that is information on paths including a plurality of nodes and edges and along which a plurality of automated guided vehicles travels, feature each of a plurality of transport requests each including information on a set of start node for each of the automated guided vehicles to receive a package and end node representing a point to which the automated guided vehicle delivers the received package by using at least one of (a) a quantity that leads to values apart from each other for transport requests at locations apart from each other and (b) a quantity that leads to values close to each other for transport requests of which transport paths for automated guided vehicles overlap, and group the transport requests based on the quantities featured for the transport requests, a transport request assigning unit configured to assign the set of transport requests, grouped by the transport request grouping unit, to each of the automated guided vehicles, and an automated guided vehicle route planning unit configured to make a plan for causing each of the automated guided vehicles to travel based on the set of transport requests, assigned to the automated guided vehicle by the transport request assigning unit, such that the automated guided vehicles do not collide with each other.

In the above aspect, the transport request grouping unit may be configured to feature each of the plurality of transport requests by using (a) the quantity that leads to values apart from each other for transport requests at locations apart from each other and (b) the quantity that leads to values close to each other for transport requests of which transport paths for automated guided vehicles overlap.

In the above aspect, the transport request grouping unit may be configured to, in accordance with (a) the quantity that leads to values apart from each other for transport requests at locations apart from each other, (a1) introduce coordinates of a middle point of a straight line connecting the start node and end node of a transport request, and the transport request grouping unit may be configured to, in accordance with (b) the quantity that leads to values close to each other for transport requests of which transport paths for automated guided vehicles overlap, (Ill) assign weights to each of the nodes on a transport path from the start node to the end node in a transport request based on the number of transport paths passing through the node and introduce a total value of the weights along the transport path.

In the above aspect, the transport request grouping unit may be configured to group the transport requests by performing clustering such that a work load of each set of transport requests is lower than or equal to a predetermined load based on the quantities featured for the transport requests.

In the above aspect, the transport request assigning unit may be configured to assign one of the sets of transport requests, grouped by the transport request grouping unit, in order from the automated guided vehicle of which end time of a last transport plan is earlier, and the transport request assigning unit may be configured to assign one of the sets of transport requests at a shortest distance from an end point of a transport plan for each of the automated guided vehicles to the automated guided vehicle.

In the above aspect, the automated guided vehicle route planning unit may be configured to determine a travel route of each of the automated guided vehicles to a route connecting shortest routes each running from the start node to the end node of each of the transport requests included in a set of transport requests, grouped by the transport request grouping unit in predetermined processing order for the transport requests.

In the above aspect, the automated guided vehicle route planning unit may be configured to plan travel timing of each of the automated guided vehicles such that the automated guided vehicles do not collide with each other by creating an overall Petri net for the automated guided vehicles by connecting Petri nets for the determined travel routes of all the automated guided vehicles and adapting a rule of a predetermined token to the created overall Petri net for the automated guided vehicles.

Another aspect of the disclosure relates to a transport planning method. The transport planning method includes, based on transport path information that is information on paths including a plurality of nodes and edges and along which a plurality of automated guided vehicles travels, featuring each of a plurality of transport requests each including information on a set of start node for each of the automated guided vehicles to receive a package and end node representing a point to which the automated guided vehicle delivers the received package by using at least one of (a) a quantity that leads to values apart from each other for transport requests at locations apart from each other and (b) a quantity that leads to values close to each other for transport requests of which transport paths for automated guided vehicles overlap, and grouping the transport requests based on the quantities featured for the transport requests, assigning the grouped set of the transport requests to each guided vehicle, and making a plan for causing each of the automated guided vehicles to travel based on the set of transport requests, assigned to the automated guided vehicle, such that each of the automated guided vehicles does not collide with another one of the automated guided vehicles.

Further another aspect of the disclosure relates to a program for causing a computer to execute processes. The processes include, based on transport path information that is information on paths including a plurality of nodes and edges and along which a plurality of automated guided vehicles travels, featuring each of a plurality of transport requests each including information on a set of start node for each of the automated guided vehicles to receive a package and end node representing a point to which the automated guided vehicle delivers the received package by using at least one of (a) a quantity that leads to values apart from each other for transport requests at locations apart from each other and (b) a quantity that leads to values close to each other for transport requests of which transport paths for automated guided vehicles overlap, and grouping the transport requests based on the quantities featured for the transport requests, assigning the grouped set of the transport requests to each guided vehicle, and making a plan for causing each of the automated guided vehicles to travel based on the set of transport requests, assigned to the automated guided vehicle, such that the automated guided vehicles do not collide with each other.

According to the aspects of the disclosure, it is possible to provide a transport planning system, a transport planning method, and a program that are capable of sufficiently reducing a computation time to make a transport plan.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic system configuration of a transport planning system according to an embodiment;

FIG. 2 is a block diagram showing a schematic configuration of a transport planning apparatus according to the embodiment;

FIG. 3 is a view showing an example of grid paths and transport requests;

FIG. 4 is a flowchart showing the flow of a method of grouping transport requests by means of clustering according to the embodiment;

FIG. 5 is a flowchart showing the flow of a specific assigning method at the time of assigning a set of transport requests to each of automated guided vehicles;

FIG. 6 is a block diagram showing a schematic system configuration of an automated guided vehicle route planning unit according to the embodiment;

FIG. 7 is a flowchart showing the flow of determining the order to process transport requests;

FIG. 8A is a view for specifically illustrating a method of determining a travel route;

FIG. 8B is a view for specifically illustrating a method of determining a travel route;

FIG. 8C is a view for specifically illustrating a method of determining a travel route;

FIG. 9 is a view showing a travel route excluding an end node and an arrow extended from the end node, from the travel route;

FIG. 10 is a diagram showing a travel route with labelled round circles and bars of paths and a Petri net expressing that an automated guided vehicle moves along the paths;

FIG. 11 is a diagram in which a place of a start node of a transport request and a transition representing movement from the start node are connected by an arrow;

FIG. 12A is a diagram in which a place of an end node of a transport request and a transition representing movement from the end node are connected by an arrow;

FIG. 12B is a diagram in which a place of an end node of a transport request and a transition representing movement from the end node are connected by an arrow;

FIG. 13A is a diagram showing connection in the case where an end node of a transport request and a start node of a subsequent transport request coincide with each other;

FIG. 13B is a diagram showing connection in the case where an end node of a transport request and a start node of a subsequent transport request coincide with each other;

FIG. 14 is a diagram in the case where a Petri net of handover is added to all the transport requests;

FIG. 15 is a diagram showing a Petri net of handover at an end node of a transport request;

FIG. 16 is a diagram showing a Petri net of a travel route;

FIG. 17A is a view showing the case where two automated guided vehicles A, B are present on paths;

FIG. 17B is a view showing the case where two automated guided vehicles A, B are present on paths;

FIG. 18 is a diagram showing a Petri net for the automated guided vehicle A and a Petri net for the automated guided vehicle B;

FIG. 19 is a diagram in the case where the Petri nets for the automated guided vehicles A, B and resource places p_{res,n} are connected;

FIG. 20A is a diagram for illustrating a rule of movement of a token;

FIG. 20B is a diagram for illustrating a rule of movement of a token;

FIG. 21 is a flowchart showing the flow of a transport planning method according to the embodiment; and

FIG. 22 is a block diagram showing the configuration of a transport planning system that does not include a transport planning apparatus.

### DETAILED DESCRIPTION OF EMBODIMENTS

### First Embodiment

Hereinafter, an embodiment of the disclosure will be described with reference to the accompanying drawings.

A transport planning system according to the present embodiment assigns, to each of a plurality of automated guided vehicles that travel on paths, a transport request including information on a pickup point and handover point of a package to be delivered by the automated guided vehicle and determines a transport route of the automated guided vehicle based on the assigned transport request. The transport planning system according to the present embodiment obtains quantities respectively representing features of transport requests, groups the transport requests into small units based on the quantities, assigns the grouped set of transport requests to each of the automated guided vehicles, and determines a transport route.

Thus, it is possible to suppress an increase in the numbers of nodes and edges representing paths of automated guided vehicles, suppress an increase in the number of combinations of node and edge, and significantly reduce a computation time to make an optimal transport plan.

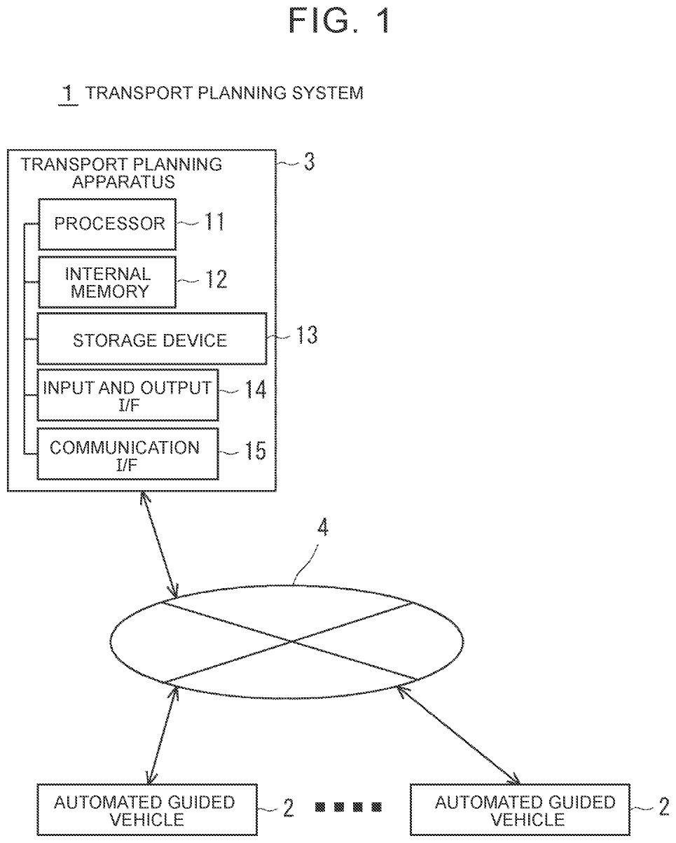

FIG. 1 is a block diagram showing a schematic system configuration of the transport planning system according to the present embodiment. The transport planning system 1 according to the present embodiment includes a plurality of automated guided vehicles 2 and a transport planning apparatus 3 that makes a transport plan for each of the automated guided vehicles 2.

The automated guided vehicles 2 and the transport planning apparatus 3 are connected via a wireless communication network 4, such as a local area network (LAN) and a wide area network (WAN), so as to communicate with one another.

Each of the automated guided vehicles 2 includes, for example, a plurality of sensors, such as distance sensors. Each of the automated guided vehicles 2 is configured as a transport robot capable of autonomously moving based on information from the sensors and transporting a package or the like.

The transport planning apparatus 3 plans the travel order, travel route, travel timing, and the like of each of the automated guided vehicles 2 at the time when the automated guided vehicle 2 transports a package. The transport planning apparatus 3 has, for example, a hardware configuration of a normal computer including a processor 11, such as a central processing unit (CPU) and a graphics processing unit (GPU), an internal memory 12, such as a random access memory (RAM) and a read only memory (ROM), a storage device 13, such as a hard disk drive (HDD) and a solid state drive (SSD), an input and output I/F 14 for connecting peripheral devices, such as a display, and a communication I/F 15 for communicating with devices outside the apparatus.

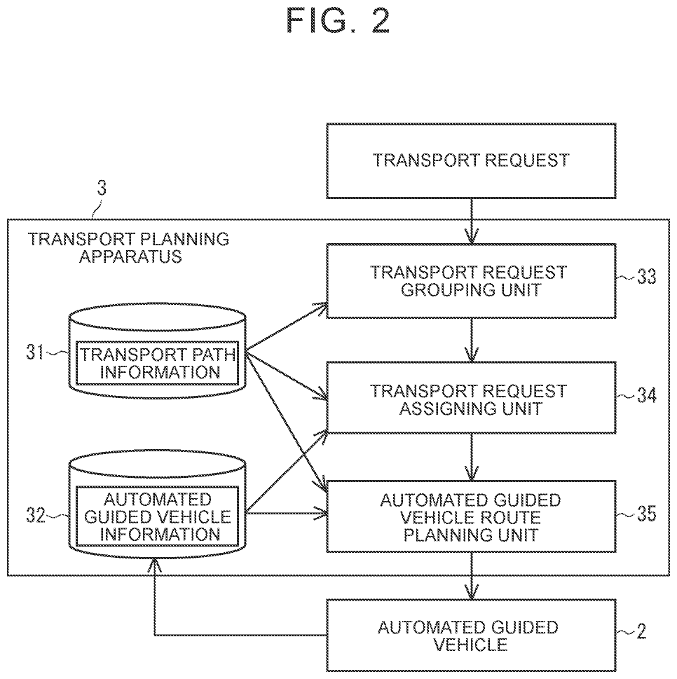

FIG. 2 is a block diagram showing a schematic configuration of the transport planning apparatus according to the present embodiment. The transport planning apparatus 3 according to the present embodiment includes a transport path information storage unit 31, an automated guided vehicle information storage unit 32, a transport request grouping unit 33, a transport request assigning unit 34, and an automated guided vehicle route planning unit 35.

The transport path information storage unit 31 stores transport path information for the automated guided vehicles 2. The transport path information is information on paths along which the automated guided vehicles 2 are able to move. The paths are composed of a grid graph including a plurality of nodes and edges. The transport path information is set in the transport path information storage unit 31 in advance.

The automated guided vehicle information storage unit 32 stores automated guided vehicle information. The automated guided vehicle information includes a node indicating a current location of the automated guided vehicle 2 and a transport plan for the automated guided vehicle 2 to perform transportation. The automated guided vehicle information is transmitted from each of the automated guided vehicles 2 and stored in the automated guided vehicle information storage unit 32.

The transport path information storage unit 31 and the automated guided vehicle information storage unit 32 are made up of, for example, the internal memory 12, the storage device 13, or the like. The transport path information storage unit 31 and the automated guided vehicle information storage unit 32 are configured as separate components; however, the configuration is not limited thereto. The transport path information storage unit 31 and the automated guided vehicle information storage unit 32 may be configured integrally.

The transport request grouping unit 33 groups a plurality of transport requests based on the transport path information stored in the transport path information storage unit 31. A transport request is information including a start node for one of the automated guided vehicles 2 to receive a package and an end node indicating a point at which the automated guided vehicle 2 delivers the received package. A transport request is generated by, for example, a server, a user, or the like that provides an instruction for transportation and is input to the transport request grouping unit 33. A transport request may be set in advance in the transport path information storage unit 31, the automated guided vehicle information storage unit 32, the transport request grouping unit 33, or the like.

The transport request assigning unit 34 assigns the set of transport requests, grouped by the transport request grouping unit 33, to each of the automated guided vehicles 2. The automated guided vehicle route planning unit 35 plans transportation of each of the automated guided vehicles 2 based on the set of transport requests, assigned to the automated guided vehicle 2 by the transport request assigning unit 34, such that the automated guided vehicles 2 do not collide with each other.

Next, each of the transport request grouping unit 33, the transport request assigning unit 34, and the automated guided vehicle route planning unit 35 will be described in detail.

### Transport Request Grouping Unit

Initially, a method of grouping transport requests by the transport request grouping unit 33 will be described. The transport request grouping unit 33 groups a plurality of transport requests based on the following basic concepts of grouping (i) and (ii).

(i) Transport requests at locations apart from each other are respectively grouped into different sets so as not to increase the travel distance of the automated guided vehicle 2.
(ii) Transport requests of which transport paths overlap each other are grouped into the same set to reduce the possibility of congestion of the automated guided vehicles 2.
Therefore, the transport request grouping unit 33 features each of a plurality of transport requests by using:
(a) a quantity that leads to values apart from each other for transport requests at locations apart from each other (which corresponds to (i)); and
(b) a quantity that leads to values close to each other for transport requests of which the transport paths of the automated guided vehicles 2 overlap (which corresponds to (ii)).
In this way, it is possible to reduce congestion of the automated guided vehicles 2 while reducing the travel distance of each of the automated guided vehicles 2 by featuring each of the transport requests by using the two quantities (a), (b), so transport efficiency is improved.

The transport request grouping unit 33 performs clustering such that a work load of each set of transport requests grouped based on the quantities featured for the transport requests becomes less than or equal to a predetermined load. The transport request grouping unit 33 groups transport requests by performing clustering that integrates similar transport requests as the same transport request from among a plurality of transport requests. The transport request grouping unit 33 uses, for example, mean shift or the like as clustering.

When transport requests are grouped as described above, the number of sets of transport requests is reduced, with the result that it is possible to reduce a computation time to make a transport plan. Furthermore, when clustering is performed such that a work load of each set of transport requests becomes less than or equal to a predetermined load, and an upper limit of a work load per one set of transport requests is determined, it is possible to easily estimate a work load for transport requests.

As one example of a specific quantity that satisfies (a), (a1) coordinates (x, y) of a middle point of a straight line connecting the start node and the end node of a transport request are introduced. As one example of a specific quantity that satisfies (b), (b1) weights are assigned to each of the nodes on a transport path from the start node to the end node in a transport request based on the number of transport paths passing through the node, and a total value w of the weights along the transport path is introduced. The set of quantities (x, y, w) is defined as a quantity that features a transport request.

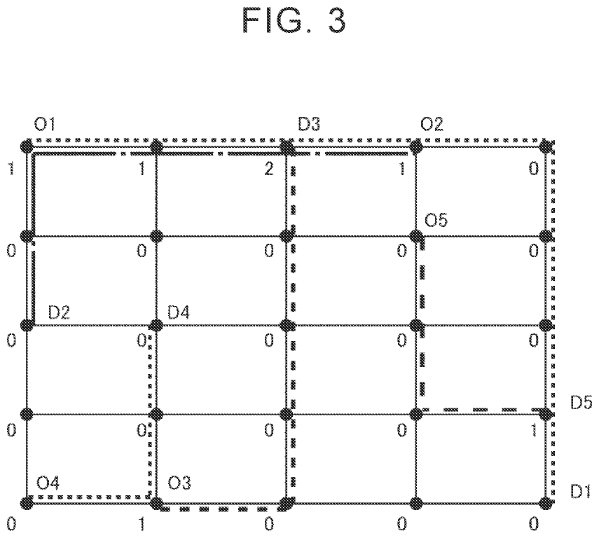

A quantity (hereinafter, overlap degree) w that indicates the degree of overlap of transport requests in the above-described (b1) will be specifically described by using an example of transport requests shown in FIG. 3. FIG. 3 is a view showing an example of grid paths and transport requests. A transport request is given by a set (O, D) of O indicating a start node of transportation and D indicating an end node of transportation. In FIG. 3, five transport requests (O1, D1), (O2, D2), (O3, D3), (O4, D4), and (O5, D5) are given.

The transport request grouping unit 33 calculates the overlap degree w of the five transport requests in accordance with the following (1) to (3).

(1) The transport request grouping unit 33 obtains a shortest route for each of the five transport requests (O1, D1), (O2, D2), (O3, D3), (O4, D4), and (O5, D5) as a representative. Hereinafter, the shortest route of each transport request is referred to as a representative path. In FIG. 3, the dotted lines and the dashed lines other than the continuous lines are the actually obtained representative paths of the transport requests. When there is a plurality of shortest routes, the transport request grouping unit 33 arbitrarily selects one from among the plurality of shortest routes.

(2) The transport request grouping unit 33 defines, based on the obtained representative paths, a value obtained by subtracting one from the number of representative paths passing through each node as the weight of the node. As shown in FIG. 3, the weight of a node through which no representative path passes is defined as zero.

For example, since each of the representative paths of the three transport requests (O1, D1), (O2, D2), and (O3, D3) passes through the node D3, a value of two obtained by subtracting one from the number of representative paths passing through the node D3, that is, three, is the weight of the node D3.

(3) The transport request grouping unit 33 calculates a total value of the weights of nodes included in the representative path of each transport request as the overlap degree w of the transport request.

In the case of FIG. 3, the overlap degrees of the five transport requests (O1, D1), (O2, D2), (O3, D3), (O4, D4), and (O5, D5) are respectively W_{(O1, D1)}=6, W_{(O2, D2)}=5, W_{(O3, D3)}=3, W_{(O6, D6)}=1, and W_{(O5, D5)}=1.

Next, a method of grouping transport requests by means of clustering using the quantities (x, y, w) that feature the transport requests will be described with a specific example.

Initially, at the time of performing clustering of transport requests, an upper limit value of the size of grouping per set is set. An upper limit value is, for example, an upper limit or the like of a total value of representative path lengths of transport requests included in a set and is an upper limit of a work load per set. An upper limit value may be set in advance by the transport request grouping unit 33 or the like.

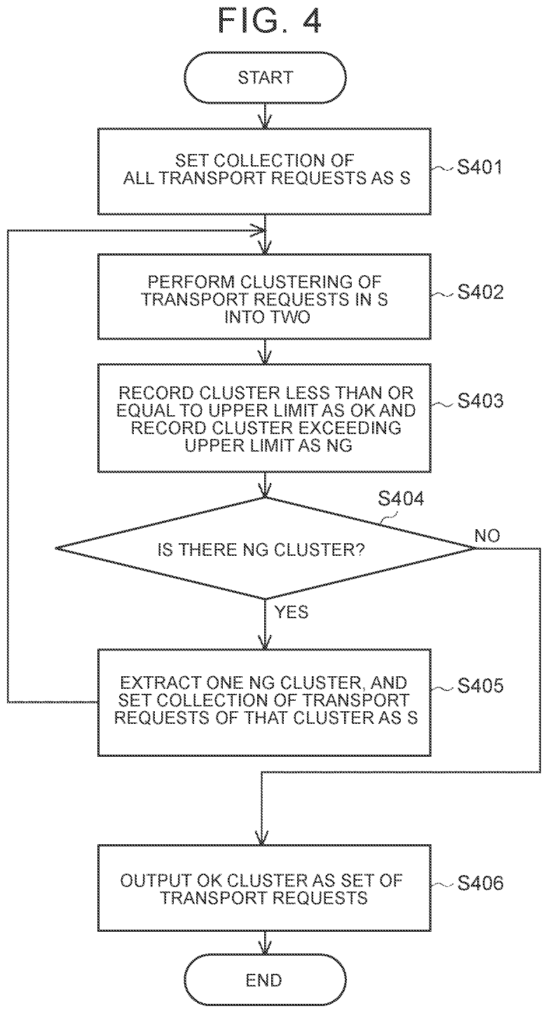

FIG. 4 is a flowchart showing the flow of a method of grouping transport requests by means of clustering according to the present embodiment.

The transport request grouping unit 33 defines a collection of all the transport request as S (step S401). The transport request grouping unit 33 performs clustering of transport requests in the collection S of the transport requests into two by using the quantities that feature the transport requests (step S402).

The transport request grouping unit 33 calculates the size of each of the two clusters obtained by clustering and checks whether the size of each cluster is less than or equal to the set upper limit value. The transport request grouping unit 33 records a cluster of which the size is less than or equal to the upper limit value as OK and records a cluster of which the size exceeds the upper limit value as NG (step S403).

The transport request grouping unit 33 checks whether there is an NG cluster in the recorded clusters (step S404). When there is any NG cluster (YES in step S404), the transport request grouping unit 33 extracts one NG cluster and sets a collection of the transport requests of that cluster as S (step S405) and returns to step S402.

When there is no NG cluster (NO in step S404), the transport request grouping unit 33 outputs the OK cluster as a set of transport requests to the transport request assigning unit 34 and ends the process (step S406).

In the above description, the transport request grouping unit 33 features each of a plurality of transport requests by using (a) a quantity that leads to values apart from each other for transport requests at locations apart from each other and (b) a quantity that leads to values close to each other for transport requests of which transport paths of automated guided vehicles overlap, and groups the transport requests based on the quantities featured for the transport requests; however, the configuration is not limited thereto. The transport request grouping unit 33 may feature each of a plurality of transport requests by using at least one of (a) a quantity that leads to values apart from each other for transport requests at locations apart from each other and (b) a quantity that leads to values close to each other for transport requests of which transport paths of automated guided vehicles overlap, and group the transport requests based on the quantities featured for the transport requests.

For example, when the number of automated guided vehicles 2 that transport packages is small, the transport request grouping unit 33 may feature each of a plurality of transport requests by using only (a) a quantity that leads to values apart from each other for transport requests at locations apart from each other. Thus, calculation is simplified, with the result that a computation time to determine a transport plan is further reduced.

### Transport Request Assigning Unit

The transport request assigning unit 34 assigns a set of transport requests, grouped by the transport request grouping unit 33, to each of the automated guided vehicles 2. The transport request assigning unit 34 acquires end time at which the last transport plan all finishes, from the automated guided vehicle information on each of the automated guided vehicles 2, stored in the automated guided vehicle information storage unit 32. The transport request assigning unit 34 assigns a set of transport requests in order from the automated guided vehicle 2 of which the end time of the last transport plan is earlier.

Based on the automated guided vehicle information on each of the automated guided vehicles 2 in the automated guided vehicle information storage unit 32, the transport request assigning unit 34 assigns, to each of the automated guided vehicles 2, a set of transport requests at the closest distance to the end point of the automated guided vehicle 2. Thus, the moving distance of the automated guided vehicle 2 is minimized, so transport efficiency is improved.

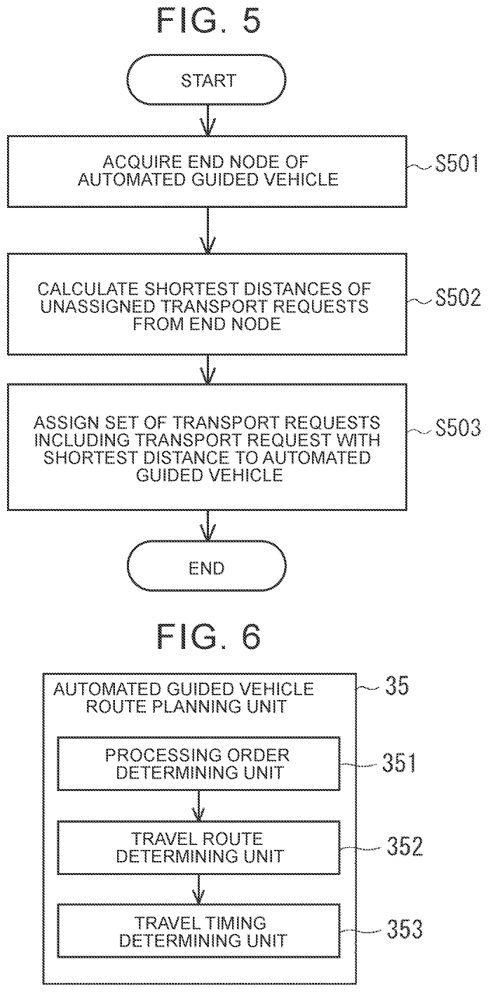

FIG. 5 is a flowchart showing the flow of a specific assigning method at the time of assigning a set of transport requests to each of the automated guided vehicles.

The transport request assigning unit 34 acquires a node (end node) at a location where each of the automated guided vehicles 2 is present at the time when the transport plan of the automated guided vehicle 2 all finishes, from the automated guided vehicle information on each of the automated guided vehicles 2, stored in the automated guided vehicle information storage unit 32 (step S501).

The transport request assigning unit 34 calculates the shortest distance from the end node to the start node of an unassigned transport request (step S502).

The transport request assigning unit 34 obtains a transport request of which a distance from the end node to the start node is the shortest and assigns a set of transport requests including the obtained transport request to the automated guided vehicle 2 (step S503).

The transport request assigning unit 34, as described above, outputs the result of the set of transport requests, assigned to each of the automated guided vehicles 2, to the automated guided vehicle route planning unit 35.

### Guided Vehicle Route Planning Unit

The automated guided vehicle route planning unit 35 determines order, travel route, and travel timing at the time when each of the automated guided vehicles 2 processes each transport request in a set of transport requests, assigned to the automated guided vehicle 2 by the transport request assigning unit 34, based on the assigned set of transport requests.

FIG. 6 is a block diagram showing a schematic system configuration of the automated guided vehicle route planning unit according to the present embodiment. The automated guided vehicle route planning unit 35 according to the present embodiment includes a processing order determining unit 351 that determines the order of transport requests, a travel route determining unit 352 that determines the travel route of the automated guided vehicle 2, and a travel timing determining unit 353 that determines the travel timing of the automated guided vehicle 2.

### Processing Order Determining Unit

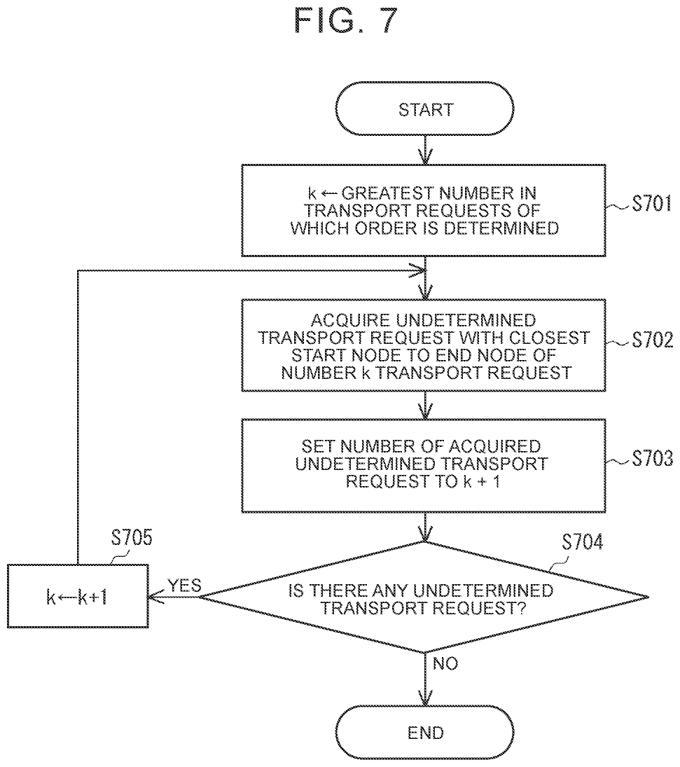

The processing order determining unit 351 determines the order to process transport requests in a set of transport requests, assigned to each of the automated guided vehicles 2. FIG. 7 is a flowchart showing the flow of determining the order to process transport requests. A number indicating the order of processing is set in advance for each of the assigned transport requests. As the number increases, processing order becomes later. A transport request for which no number is set is defined as an undetermined transport request. The processing order determining unit 351 determines the order in which the automated guided vehicle 2 processes the undetermined transport request, as follows.

The processing order determining unit 351 records the greatest number from among transport requests for which the order is determined and defines the recorded number as k (step S701).

The processing order determining unit 351 calculates the shortest route length from the end node of the transport request of the recorded number k to the start node of each of all the undetermined transport requests and acquires the undetermined transport request of which the shortest route length is the shortest (step S702).

The processing order determining unit 351 sets the number of the acquired undetermined transport request to k+1 (step S703).

The processing order determining unit 351 checks whether there is any undetermined transport request (step S704). When the processing order determining unit 351 determines that there is an undetermined transport request (YES in step S704), the processing order determining unit 351 records k+1 as k (step S705), and returns to the process of step S702. On the other hand, when the processing order determining unit 351 determines that there is no undetermined transport request (NO in step S704), the processing order determining unit 351 ends the process.

The processing order determining unit 351 outputs the thus determined processing order of the transport requests to the travel route determining unit 352.

### Travel Route Determining Unit

The travel route determining unit 352 determines the travel route of the automated guided vehicle 2 based on the order of processing of transport requests, determined by the processing order determining unit 351.

Specifically, the travel route determining unit 352 selects the representative path of the transport request, used by the transport request grouping unit 33, as a travel route. The travel route determining unit 352, after completion of a transport request, selects one of the shortest routes headed to the start node of the next transport request. The travel route determining unit 352 determines a route connected in the order of processing of transport requests for the travel route of the automated guided vehicle 2. Thus, it is possible to efficiently transport packages along the shortest route in the set order of processing of transport requests.

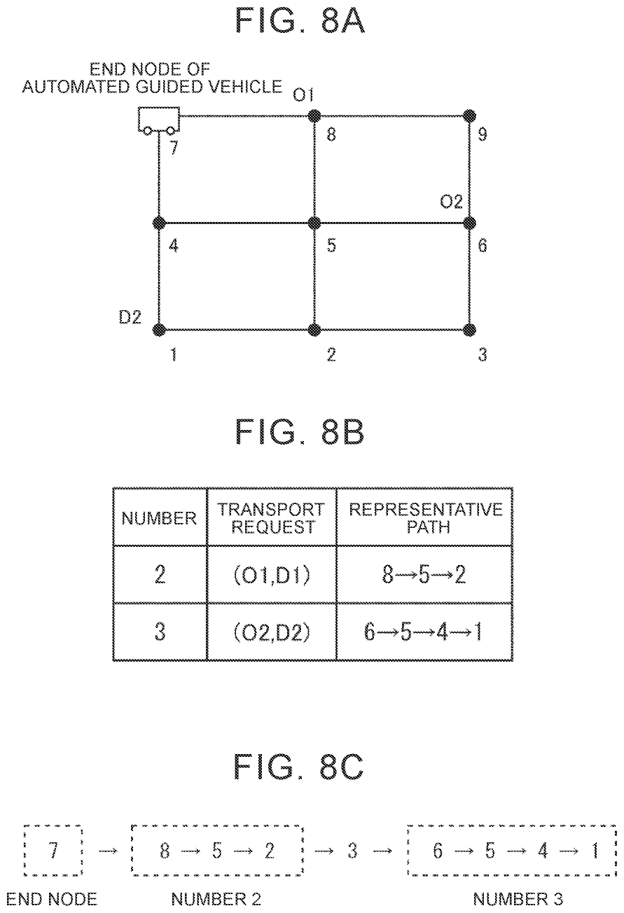

FIG. 8A, FIG. 8B, and FIG. 8C are views for specifically illustrating a method of determining a travel route. FIG. 8A is an example of grid paths. FIG. 8B is an example of transport requests.

As shown in FIG. 8B, the travel route determining unit 352 selects a representative path (8→5→2) of a number 2 transport request (O1, D1) and a representative path (6→5→4 1) of a number 3 transport request (O2, D2), and, after the number 2 transport request, selects node 3 that makes up the shortest route for a transport route headed to the start node of the next number 3 transport request. Then, as shown in FIG. 8C, the travel route determining unit 352 determines the travel route of the automated guided vehicle 2 to a route (7→(8→5→2)→3→(6→5→4→1)) connecting the last end node 7 and the selected nodes in order of processing of the transport requests.

The travel route determining unit 352 outputs the thus determined travel route of each of the automated guided vehicles 2 to the travel timing determining unit 353.

### Travel Timing Determining Unit

The travel timing determining unit 353 determines the travel timing of each of the automated guided vehicles 2 based on the travel route of the automated guided vehicle 2, determined by the travel route determining unit 352, such that a collision between the automated guided vehicles 2 is prevented.

The travel timing determining unit 353 describes the travel route of each of the automated guided vehicles 2, determined by the travel route determining unit 352, by means of, for example, an expression method called a Petri net. The travel timing determining unit 353 connects Petri nets for the paths of all the automated guided vehicles 2 and calculates the travel timing of each of the automated guided vehicles 2, at which the automated guided vehicles 2 do not collide with each other. It is assumed that the travel timing determining unit 353 stores a Petri net created by the last time and is able to read out the Petri net.

Initially, a method of creating a Petri net will be specifically described by using the travel route shown in FIG. 8C.

### Step 1

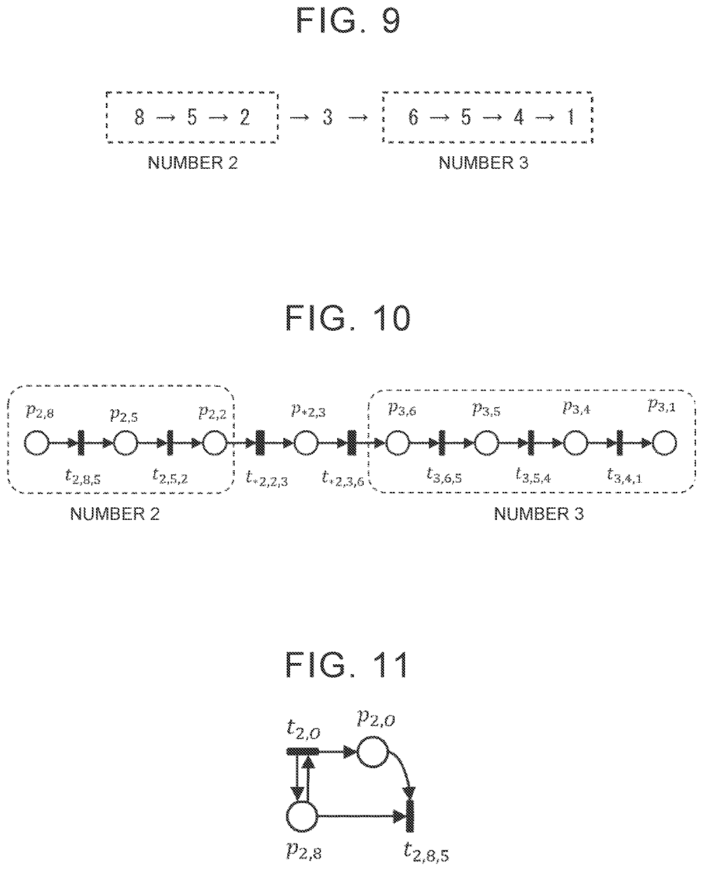

A travel route excluding an end node and an arrow extended from the end node, from the travel route shown in FIG. 8C is created (FIG. 9).

### Step 2

In the travel route shown in FIG. 9, node numbers are replaced with round circles (O), and arrows (→) are replaced with sets of arrows and bar “→|→”. The round circles and the bars are labelled as follows (FIG. 10).
Label a round circle corresponding to node number m in a number n transport request with p_{n,m}.
Label a round circle corresponding to node number k while, after finishing the number n transport request, moving to the next transport request with p*_{n,k}.
Label a bar corresponding to movement from node number m to m′ in the number n transport request with t_{n,m,m′}.
Label a bar corresponding to movement from node number k to k′ while, after finishing the number n transport request, moving to the next transport request with t*_{n,k,k′}.

However, it is assumed that, when there is a node at which the end point of the number n transport request and the start point of the next transport request coincide with each other, the label of a corresponding round circle is p′_{n,m} (m is node number).

FIG. 10 is a diagram showing paths obtained by labelling the round circles and bars of the paths of FIG. 9 with the labels and a Petri net expressing that the automated guided vehicle 2 moves along the paths.

The round circles and the bars in FIG. 10 are respectively referred to as places and transitions and represent the following situations.
p_{n,m}: A state where the automated guided vehicle 2 is at node number m during transportation of the number n transport request
p*_{n,m}: A state where, after the automated guided vehicle 2 finishes the number n transport request, the automated guided vehicle 2 is at node number m while moving to the next transport request
t_{n,i,j}: An event in which the automated guided vehicle 2 moves from node number i to j during transportation of the number n transport request
t*_{n,i,j}: An event in which, after the automated guided vehicle 2 finishes the number n transport request, the automated guided vehicle 2 moves from node number i to j to move to the next transport request

An arrow connecting a place and a transition of a Petri net expresses the condition and direction of a change in state. For example, t_{2,8,5} in FIG. 10 expresses “a state of movement from node number 8 to node number 5 in the number 2 transport request”.

### Step 3

A Petri net expressing a pickup and handover of a package is added to the Petri net shown in FIG. 10. Hereinafter, the number 2 transport request will be described as an example.

Initially, to express a pickup of a package of the number 2 transport request, the next transition and place are introduced.
A transition expressing an event in which a package is picked up at the start node is represented by t_{2,0}.
A place expressing a state where a pickup of the package is complete at the start node is represented by p_{2,0}.

Then, the place p_{2,8} at the start node of the number 2 transport request and the transition t_{2,8,5} expressing movement from the start node are connected by an arrow as shown in FIG. 11.

For a handover of a package, as well as the pickup of a package, the following place and transition are introduced.
A transition expressing an event in which a package is picked up at the end node is represented by t_{2,D}.
A place expressing a state where a pickup of the package is complete at the end node is represented by p_{2,D}.

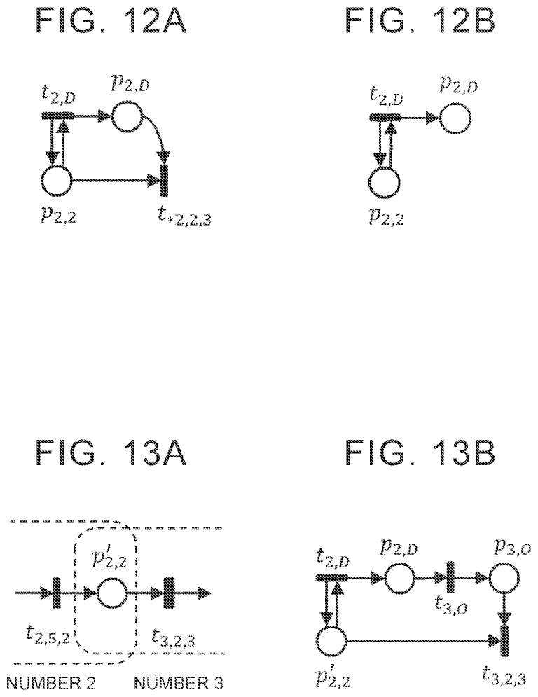

Then, the place p_{2,D} at the end node of the number 2 transport request and the transition t*_{2,2,3} expressing movement from the end node are connected by an arrow as shown in FIG. 12A. However, when there is no transition t*_{2,2,3} expressing movement from the end node, connection is performed as shown in FIG. 12B.

As shown in FIG. 13A, when the end node of the number 2 transport request and the start node of the next number 3 transport request coincide with each other at node number 2, connection is performed as shown in FIG. 13B.

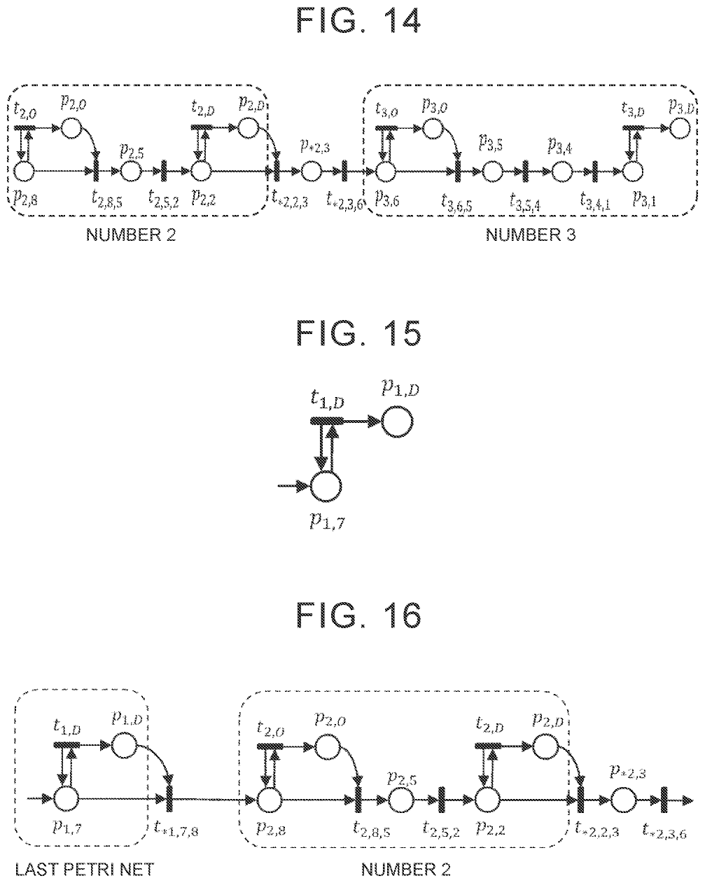

When such addition of a Petri net of a pickup and a handover is performed on all the transport request, the Petri net as shown in FIG. 14 is obtained.

### Step 4

Lastly, the Petri net for the automated guided vehicle 2 itself and the Petri nets of FIG. 13A and FIG. 13B are connected. In the case of the travel route shown in FIG. 8A, FIG. 8B, and FIG. 8C, the Petri net for the automated guided vehicle 2 is a Petri net of a handover at the end node of the number 1 transport request as shown in FIG. 15. In FIG. 15, portions other than necessary portions for description are omitted for the sake of easy understanding.

By connecting the Petri net for the automated guided vehicle 2 shown in FIG. 15 and the Petri net shown in FIG. 14 with the method of Step 2 and Step 3, a Petri net of the travel route, shown in FIG. 16, is created. In FIG. 16, the Petri net is partially omitted for the sake of easy understanding.

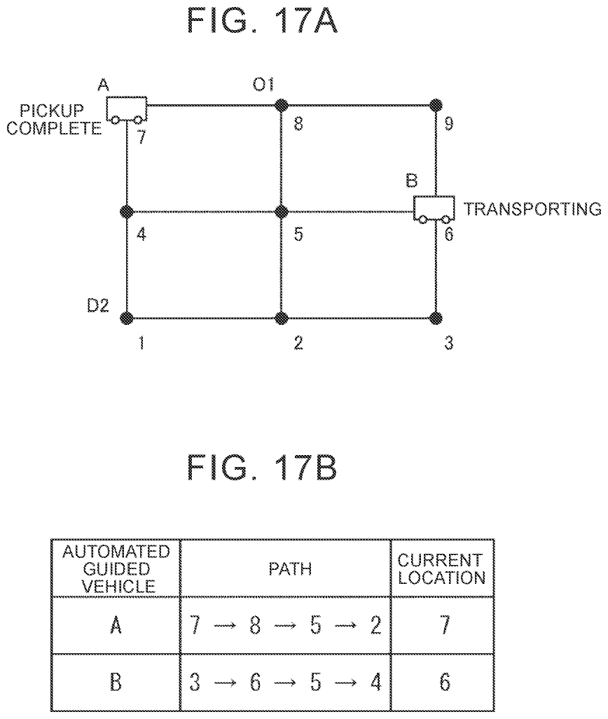

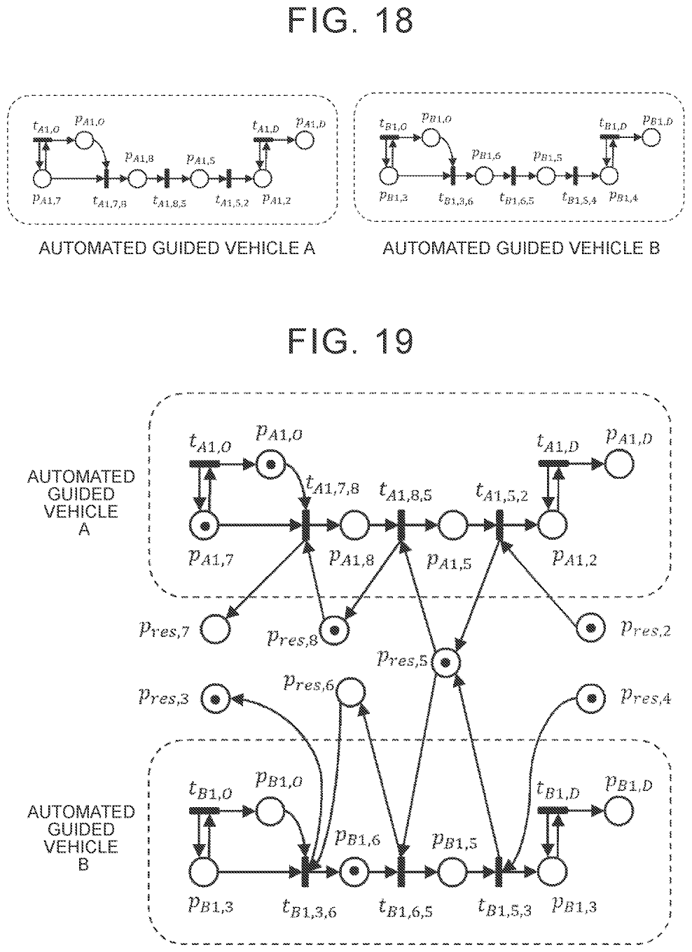

Next, a method of obtaining travel timing from the thus created Petri net will be described in the case where two automated guided vehicles A, B are present on paths as shown in FIG. 17A and FIG. 17B. FIG. 18 shows a Petri net for the automated guided vehicle A and a Petri net for the automated guided vehicle B of FIG. 17A and FIG. 17B.

Step 1

A corresponding place p_{res,n} (n=1, 2, . . . , 9) is introduced to each of all the node numbers in FIG. 17A and FIG. 17B. p_{res,n} is a place indicating a state where the automated guided vehicle 2 is able to enter node number n. res denotes a resource to accept the automated guided vehicle 2. Hereinafter, the p_{res,n} is referred to as a resource place.

An arrow is added in accordance with the following rule between the resource place p_{res,n} and a transition of the Petri net for each of the automated guided vehicles 2.
An arrow is added from a transition representing movement from node number n to another node to the resource place p_{res,n}.
An arrow is added from the resource place p_{res,n} to a transition representing movement from other than node number n to node number n.

When the Petri net for the automated guided vehicle A and the Petri net for the automated guided vehicle B, shown in FIG. 18, and the resource place p_{res,n} are connected, the result is as shown in FIG. 19.

### Step 2

A bullet token • is added to all the Petri nets connected as described above, and the current state is expressed.

The token • is put in a place O, and a state indicated by the place in which the token is put represents the current state.

As shown in FIG. 17A and FIG. 17B, since the automated guided vehicle A has completed a pickup of a package at node number 7, a token is put in a place p_{A1,7} and a place p_{A1,0} for the automated guided vehicle A as shown in FIG. 19. Similarly, as shown in FIG. 17A and FIG. 17B, since the automated guided vehicle B is at node number 6, a token is put in a place p_{B1,6} for the automated guided vehicle B and a token is also put in a place p_{res,n} corresponding to a node where no automated guided vehicle 2 is present as shown in FIG. 19.

### Step 3

The tokens on the Petri net are moved in accordance with a rule.

The token on each of the places of the Petri net is able to be changed in accordance with the following rule.
When all the places with arrows headed toward a transition t have one or more tokens, one token is removed from all the places with arrows headed to the transition t, and one token is added to all the places with arrows headed from the transition t.

This is a rule expressing transition from a current state to a next state, and the motions of the automated guided vehicles 2 are able to be simulated by observing a change in token.

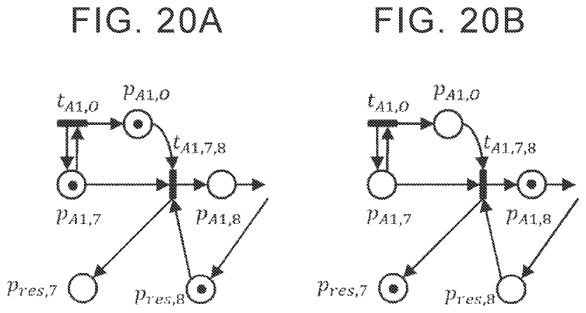

An one example, a transition t_{A1,7,8} shown in FIG. 19 is focused. As shown in FIG. 20A, each of the places p_{A1,0}, p_{A1,7}, p_{res,8} with arrows headed to the transition t_{A1,7,8} has a token. For this reason, the locations of tokens will be as shown in FIG. 20B in accordance with the rule of movement of token.

The current state of FIG. 20A expresses the following state (FIG. 20B).
The automated guided vehicle A is at node number 7 (p_{A1,7}).
A pickup of a package is complete (p_{A1,0}).
The automated guided vehicle 2 is able to enter node number 8 (p_{res,8}).
   In addition, an event of t_{A1,7,8}, that is, “movement of the automated guided vehicle A from node number 7 to 8” is possible, and a state after the event occurs expresses the following state (FIG. 20B).
The automated guided vehicle A is at node number 8 (p_{A1,8}).
A transition into a state (p_{res,7}) where the automated guided vehicle 2 is able to enter node number 7.

As an important point, in accordance with the rule of a change in token, when the automated guided vehicle 2 is at node number n, the resource place p_{res,n} has no token. For this reason, until the automated guided vehicle 2 at node number n moves, an event in which another automated guided vehicle 2 moves to node number n is not able to occur, and the automated guided vehicles 2 do not collide with each other.

It is clear that the automated guided vehicle A and the automated guided vehicle B do not collide with each other with the help of, for example, the resource place p_{res,5} at node number 5, shown in FIG. 19. For this reason, the rule of a change in token is adapted to the Petri net for all the automated guided vehicles 2, and a change in token is recorded. Thus, it is possible to determine travel timing at which the automated guided vehicles 2 do not collide with each other.

The travel timing determining unit 353 creates the Petri net for all the automated guided vehicles 2 by connecting Petri nets for the travel routes of all the automated guided vehicles 2, determined by the travel route determining unit 352, as described above. Then, the travel timing determining unit 353 plans the travel timing of each of each of the automated guided vehicles such that the automated guided vehicles do not collide with each other by adapting the rule of token to the created Petri net for all the automated guided vehicles 2. Thus, it is possible to plan the optimal travel timing of each of the automated guided vehicles 2 such that the automated guided vehicles do not collide with each other by using the Petri net. The travel timing determining unit 353 may plan the optimal travel timing of each of the automated guided vehicles 2 such that the automated guided vehicles do not collide with each other by using a selected method other than the Petri net.

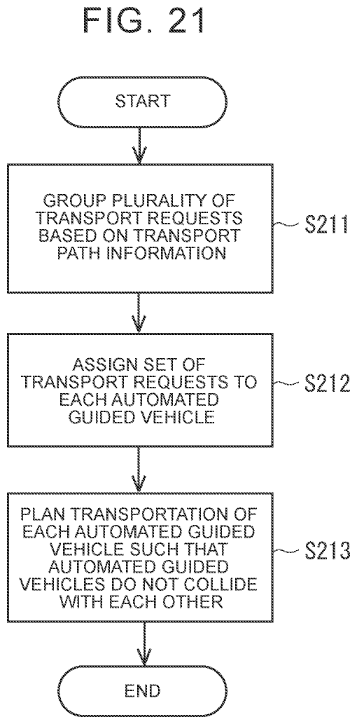

Next, a transport planning method according to the present embodiment will be described in detail. FIG. 21 is a flowchart showing the flow of the transport planning method according to the present embodiment.

The transport request grouping unit 33 groups a plurality of transport requests based on transport path information stored in the transport path information storage unit 31, and outputs the grouped sets of transport requests to the transport request assigning unit 34 (step S211).

The transport request assigning unit 34 assigns the set of transport requests, grouped by the transport request grouping unit 33, to each of the automated guided vehicles 2 (step S212), and outputs the assigned results to the automated guided vehicle route planning unit 35.

The automated guided vehicle route planning unit 35 plans transportation of each of the automated guided vehicles 2 based on the set of transport requests, assigned to the automated guided vehicle 2 by the transport request assigning unit 34, such that the automated guided vehicles 2 do not collide with each other (step S213).

The transport planning system 1 according to the first embodiment includes the transport request grouping unit 33 configured to, based on transport path information that is information on paths including a plurality of nodes and edges and along which the plurality of automated guided vehicles 2 travels, feature each of a plurality of transport requests each including information on a set of start node for each of the automated guided vehicles 2 to receive a package and end node representing a point to which the automated guided vehicle 2 delivers the received package by using at least one of (a) a quantity that leads to values apart from each other for transport requests at locations far from each other and (b) a quantity that leads to values close to each other for transport requests of which transport paths of the automated guided vehicles 2 overlap, and group the transport requests based on the quantities featured for the transport requests, the transport request assigning unit 34 configured to assign the set of transport requests, grouped by the transport request grouping unit 33, to each of the automated guided vehicles 2, and the automated guided vehicle route planning unit 35 configured to make a plan for causing each of the automated guided vehicles 2 to travel based on the set of transport requests, assigned to each of the automated guided vehicles 2 by the transport request assigning unit 34, such that the automated guided vehicles 2 do not collide with each other.

With the transport planning system 1 according to the first embodiment, transport requests are featured by using at least one of (a) a quantity that leads to values apart from each other for transport requests at locations far from each other and (b) a quantity that leads to values close to each other for transport requests of which transport paths for automated guided vehicles overlap, and the transport requests are grouped based on the quantities featured for the transport requests. Thus, the number of sets of transport requests is reduced, with the result that a computation time to make a transport plan is reduced.

### Second Embodiment

In the above-described transport planning system 1, each of the functions provided in the transport planning apparatus 3 and the automated guided vehicle 2 may be disposed in any apparatus side depending on usage. At least one of the transport path information storage unit 31, the automated guided vehicle information storage unit 32, the transport request grouping unit 33, the transport request assigning unit 34, and the automated guided vehicle route planning unit 35 of the transport planning apparatus 3 may be disposed in the automated guided vehicle 2 side.

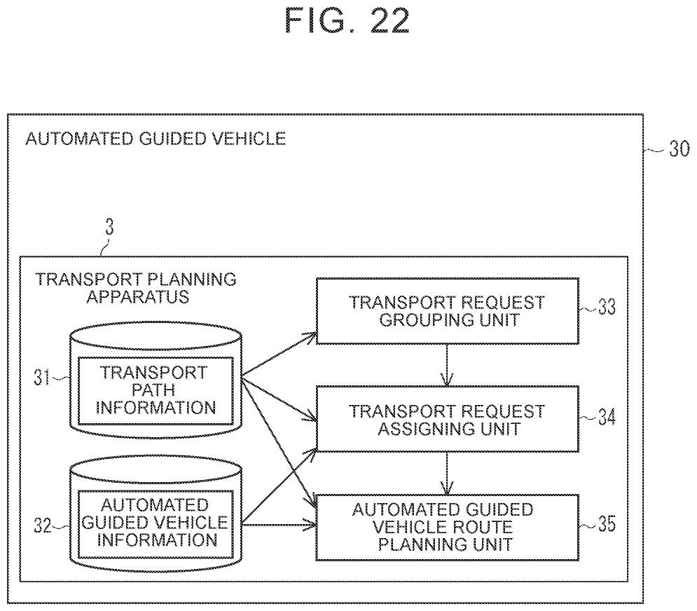

For example, as shown in FIG. 22, a transport planning system 10 may be configured not to include the transport planning apparatus 3. In this case, an automated guided vehicle 30 includes the transport path information storage unit 31, the automated guided vehicle information storage unit 32, the transport request grouping unit 33, the transport request assigning unit 34, and the automated guided vehicle route planning unit 35.

Some embodiments of the disclosure are described. The embodiments are only provided for illustrative purposes and are not intended to limit the scope of the disclosure. The new embodiments may be implemented in other various modes and may be variously omitted, replaced, or changed without departing from the purport of the disclosure. The embodiments and their modifications fall within the scope and purport of the disclosure and also fall within the scope of the disclosure recited in the appended claims and equivalents thereof.

The disclosure is able to implement the processes shown in FIG. 20A and FIG. 20B by causing a processor to run a computer program.

A program can be stored in various types of non-transitory computer readable media and can be supplied to a computer. The non-transitory computer readable media include various types of tangible storage media. Examples of the non-transitory computer readable media include a magnetic recording medium (such as a flexible disk, a magnetic tape, and a hard disk drive), a magnetooptical recording medium (such as a magneto-optical disk), a CD-read only memory (ROM), a CD-R, CD-R/W, a semiconductor memory (such as a mask ROM, a programmable ROM (PROM), an erasable PROM (EPROM), a flash ROM, and a random access memory (RAM)).

The program may be supplied to a computer via various types of transitory computer readable media. Examples of the transitory computer readable media include an electrical signal, an optical signal, and an electromagnetic wave. A transitory computer readable medium is able to supply the program to a computer via a wired communication path, such as an electric wire and an optical fiber, or a wireless communication path.

Not only various units that make up the transport planning apparatus 3 according to the above-described embodiments are implemented by a program, but also some or all of the various units may be implemented by dedicated hardware, such as an application specific integrated circuit (ASIC) and a field-programmable gate array (FPGA).

What is claimed is:

1. A transport planning system comprising:
a transport request grouping unit configured to, based on transport path information that is information on paths including a plurality of nodes and edges and along which a plurality of automated guided vehicles travels, feature each of a plurality of transport requests each including information on a set of start node for each of the automated guided vehicles to receive a package and end node representing a point to which the automated guided vehicle delivers the received package by using at least one of (a) a quantity that leads to values apart from each other for transport requests at locations apart from each other and (b) a quantity that leads to values close to each other for transport requests of which transport paths for automated guided vehicles overlap, and group the transport requests based on the quantities featured for the transport requests;
a transport request assigning unit configured to assign the set of transport requests, grouped by the transport request grouping unit, to each of the automated guided vehicles; and
an automated guided vehicle route planning unit configured to make a plan for causing each of the automated guided vehicles to travel based on the set of transport requests, assigned to the automated guided vehicle by the transport request assigning unit, such that the automated guided vehicles do not collide with each other.

2. The transport planning system according to claim 1, wherein the transport request grouping unit is configured to feature each of the plurality of transport requests by using (a) the quantity that leads to values apart from each other for transport requests at locations apart from each other and (b) the quantity that leads to values close to each other for transport requests of which transport paths for automated guided vehicles overlap.

3. The transport planning system according to claim 2, wherein:
the transport request grouping unit is configured to, in accordance with (a) the quantity that leads to values apart from each other for transport requests at locations apart from each other, (a1) introduce coordinates of a middle point of a straight line connecting the start node and end node of a transport request; and
the transport request grouping unit is configured to, in accordance with (b) the quantity that leads to values close to each other for transport requests of which transport paths for automated guided vehicles overlap, (b1) assign weights to each of the nodes on a transport path from the start node to the end node in a transport request based on the number of transport paths passing through the node and introduce a total value of the weights along the transport path.

4. The transport planning system according to claim 1, wherein the transport request grouping unit is configured to group the transport requests by performing clustering such that a work load of each set of transport requests is lower than or equal to a predetermined load based on the quantities featured for the transport requests.

5. The transport planning system according to claim 1, wherein:
the transport request assigning unit is configured to assign one of the sets of transport requests, grouped by the transport request grouping unit, in order from the automated guided vehicle of which end time of a last transport plan is earlier; and
the transport request assigning unit is configured to assign one of the sets of transport requests at a shortest distance from an end point of a transport plan for each of the automated guided vehicles to the automated guided vehicle.

6. The transport planning system according to claim 1, wherein the automated guided vehicle route planning unit is configured to determine a travel route of each of the automated guided vehicles to a route connecting shortest routes each running from the start node to the end node of each of the transport requests included in a set of transport requests, grouped by the transport request grouping unit in predetermined processing order for the transport requests.

7. The transport planning system according to claim 6, wherein the automated guided vehicle route planning unit is configured to plan travel timing of each of the automated guided vehicles such that the automated guided vehicles do not collide with each other by creating an overall Petri net for the automated guided vehicles by connecting Petri nets for the determined travel routes of all the automated guided vehicles and adapting a rule of a predetermined token to the created overall Petri net for the automated guided vehicles.

8. A transport planning method comprising:
based on transport path information that is information on paths including a plurality of nodes and edges and along which a plurality of automated guided vehicles travels, featuring each of a plurality of transport requests each including information on a set of start node for each of the automated guided vehicles to receive a package and end node representing a point to which the automated guided vehicle delivers the received package by using at least one of (a) a quantity that leads to values apart from each other for transport requests at locations apart from each other and (b) a quantity that leads to values close to each other for transport requests of which transport paths for automated guided vehicles overlap, and grouping the transport requests based on the quantities featured for the transport requests;
assigning the grouped set of transport requests to each of the automated guided vehicles; and
making a plan for causing each of the automated guided vehicles to travel based on the set of transport requests, assigned to the automated guided vehicle, such that the automated guided vehicles do not collide with each other.

9. A program causing a computer to execute processes, the processes comprising:
based on transport path information that is information on paths including a plurality of nodes and edges and along which a plurality of automated guided vehicles travels, featuring each of a plurality of transport requests each including information on a set of start node for each of the automated guided vehicles to receive a package and end node representing a point to which the automated guided vehicle delivers the received package by using at least one of (a) a quantity that leads to values apart from each other for transport requests at locations apart from each other and (b) a quantity that leads to values close to each other for transport requests of which transport paths for automated guided vehicles overlap, and grouping the transport requests based on the quantities featured for the transport requests;
assigning the grouped set of the transport requests to each automated guided vehicle; and
making a plan for causing each of the automated guided vehicles to travel based on the set of transport requests, assigned to the automated guided vehicle, such that the automated guided vehicles do not collide with each other.
